(19) United States
(12) Patent Application Publication
(10) Pub. No.: US 2009/0243433 A1
(43) Pub. Date: Oct. 1, 2009

(54) Apparatus, system and method for converting vibrational energy to electric potential

(76) Inventors: Joe Dirr, Rockford, IL (US); Jeff Slayton, Elmwood Park, IL (US)

Correspondence Address: PATENTS+TMS, P.C., 2849 W. ARMITAGE AVE., CHICAGO, IL, 60647, US

(21) Appl. No.: 12/080,224

(22) Filed: Apr. 1, 2008

(51) Int. Cl. H02J 7/02; H04M 1/00; H02N 2/18

(52) U.S. Cl. 310/319; 455/573; 320/114

(57) ABSTRACT

An apparatus, a system and a method convert vibrational energy to electric potential. The apparatus, the system and the method use vibrational energy to provide voltage to an electrical device. A piezoelectric element converts the vibrational energy to electric potential. The vibrational energy allows the electrical device to recharge a battery or function without a battery and/or exterior electrical wires.

### BACKGROUND OF THE INVENTION

The present invention generally relates to an apparatus, a system and a method for converting vibrational energy to electric potential. More specifically, the present invention relates to an apparatus, a system and a method for using vibrational energy from sound to provide voltage to an electrical device. The apparatus, the system and the method may use a piezoelectric element to convert the vibrational energy to electric potential. Use of the vibrational energy may allow electrical devices to function without a battery and/or exterior electrical wires. The apparatus, the system and the method for converting vibrational energy to electric potential may allow continuous use of an electrical device without a need for recharging.

It is generally known that an electrical device may utilize electric potential of a battery. The battery converts chemical energy into the electric potential. Chemicals within the battery are consumed by conversion of the chemical energy to the electric potential. Consumption of the chemicals within the battery causes the battery to cease to provide the electric potential to the electrical device. Therefore, the electrical device may cease functioning during use and cause inconvenience to a user of the electrical device.

A rechargeable battery may be used to provide the current to the electrical device. Recharging of the rechargeable battery requires application of a charging current to the rechargeable battery. As a result, another electrical source must be used to recharge the rechargeable battery. Thus, the recharging of the rechargeable battery may be inconvenient and/or time-consuming. Further, the user must remember to recharge the rechargeable battery, or the electrical device will continue to lack function.

Batteries that no longer provide electric potential are usually discarded. Rechargeable batteries are also usually discarded since the rechargeable battery may only be recharged a limited number of times. Discarded batteries may have toxic materials and/or non-biodegradable compounds that harm the environment.

Electrical devices are also generally known to utilize electric potential provided by wall sockets that are connected to a commercial power supply. The electrical device has an exterior wire that connects to the wall sockets and receives the electric potential from the wall sockets. A length of the exterior wire limits a distance of the electrical device from the wall socket. For example, a distance of a home stereo from a wall socket may be limited by a length of the exterior wire that connects the home stereo to the wall socket. A speaker may be attached to the home stereo; a distance of the speaker from the home stereo may be limited by a length of an exterior wire that connects that speaker to the home stereo. Further, the type of exterior wire must match the type of wall socket. For example, a three-pronged plug on the exterior wire may require a convertor to connect to a two-hole wall socket.

A need, therefore, exists for an apparatus, a system and a method for converting vibrational energy to electric potential. Further, a need exists for an apparatus, a system and a method for converting vibrational energy to electric potential which allow an electrical device to function without a battery and/or exterior electrical wires. Still further, a need exists for an apparatus, a system and a method for converting vibrational energy to electric potential which provide voltage to an electrical device. Moreover, a need exists for an apparatus, a system and a method for converting vibrational energy to electric potential which allow continuous use of an electrical device without a need for recharging.

### SUMMARY OF THE INVENTION

The present invention generally relates to an apparatus, a system and a method for converting vibrational energy to electric potential. More specifically, the present invention relates to an apparatus, a system and a method for using vibrational energy from sound to provide voltage to an electrical device. Voltage stored in a capacitor may initiate function of the electrical device, and vibrational energy produced by the function of the electrical device may provide current for continued function. Use of the vibrational energy may allow electrical devices to function without a battery and/or exterior electrical wires. The apparatus, the system and the method for converting vibrational energy to electric potential may allow continuous use of an electrical device without a need for recharging.

To this end, in an embodiment of the present invention, a system for providing power to an electrical device is provided. The system has a piezoelectric element wherein the piezoelectric element is manufactured from a crystal that does not have a center of symmetry wherein the piezoelectric element generates an electric potential in response to vibration. The system has a rectifier connected to the piezoelectric element wherein input for the rectifier is the electric potential generated by the piezoelectric element in AC voltage and output for the rectifier is the electric potential in DC voltage.

In an embodiment, the system has an amplifier connected to the piezoelectric element wherein the amplifier increases the electric potential generated by the piezoelectric element.

In an embodiment, the system has an amplifier connected to the rectifier wherein the amplifier allows the electric potential to be processed as an AC signal.

In an embodiment, the system has a capacitor connected to the piezoelectric element.

In an embodiment, the system has an electrode connected to the piezoelectric element wherein the electrode transmits the electric potential from the piezoelectric element to the rectifier.

In an embodiment, the system has connecting means attached to the piezoelectric element and the rectifier.

In another embodiment of the present invention, an apparatus for providing power to a mobile phone is provided. The mobile phone has a battery charged by the apparatus. The apparatus has a piezoelectric component wherein the piezoelectric component is manufactured from a crystal that does not have a center of symmetry wherein the piezoelectric component generates an electric potential in response to vibration; and connecting means attached to the piezoelectric component.

In an embodiment, the apparatus has an amplifier connected to the piezoelectric component wherein the amplifier increases the electric potential generated by the piezoelectric component.

In an embodiment, the apparatus has a rectifier connected to the piezoelectric component wherein input for the rectifier is the electric potential generated by the piezoelectric component in AC voltage and the output for the rectifier is the electric potential in DC voltage.

In an embodiment, the apparatus has an electrode connected to the piezoelectric component wherein the electrode receives the electric potential from the piezoelectric component.

In another embodiment of the present invention, a method for providing electrical power to an electrical device is provided. The electrical device has an exterior and an interior. The method has the steps of converting vibrations to electric potential wherein the vibrations are converted to the electrical potential by a piezoelectric element wherein the piezoelectric element is manufactured from a crystal that does not have a center of symmetry; and transmitting the electrical potential to the electrical device.

In an embodiment, the method has the step of amplifying the electrical potential.

In an embodiment, the method has the step of charging a battery of the electrical device with the electrical potential.

In an embodiment, the method has the step of transmitting power from a battery of the electrical device if the electrical potential converted from the vibrations is less than a predetermined amount.

In an embodiment, the method has the step of converting the electrical potential from AC voltage to DC voltage.

In an embodiment, the method has the step of activating the electrical device with the electrical potential.

In an embodiment, the method has the step of using the electrical potential to sustain a function of the electrical device.

In an embodiment, the method has the step of processing the electrical potential.

In an embodiment, the method has the step of connecting the piezoelectric element to the exterior of the electrical device.

In an embodiment, the method has the step of connecting the piezoelectric element to the interior of the electrical device.

It is, therefore, an advantage of the present invention to provide an apparatus, a system and a method for converting vibrational energy to electric potential.

Another advantage of the present invention is to provide an apparatus, a system and a method for converting vibrational energy to electric potential which use vibrational energy from sound to provide voltage to an electrical device.

A further advantage of the present invention is to provide an apparatus, a system and a method for converting vibrational energy to electric potential which allow continuous use of an electrical device without a need for recharging.

And, another advantage of the present invention is to provide an apparatus, a system and a method for converting vibrational energy to electric potential which initiate function of the electrical device using voltage stored in a capacitor.

A still further of the present invention is to provide an apparatus, a system and a method for converting vibrational energy to electric potential which allow electrical devices to function without a battery.

And, another advantage of the present invention is to provide an apparatus, a system and a method for converting vibrational energy to electric potential which allow electrical devices to function without exterior electrical wires.

Moreover, an advantage of the present invention is to provide an apparatus, a system and a method for converting vibrational energy to electric potential which may initiate function of an electrical device without an initial voltage from a battery or external source.

And, another advantage of the present invention is to provide an apparatus, a system and a method for converting vibrational energy to electric potential which may convert current between alternating current (“AC”) and direct current (“DC”).

A still further advantage of the present invention is to provide an apparatus, a system and a method for converting vibrational energy to electric potential which may reduce and/or eliminate disposal of batteries.

Yet another advantage of the present invention is to provide an apparatus, a system and a method for converting vibrational energy to electric potential which may use a pre-amplifier to convert vibrational energy to electrical potential.

A still further advantage of the present invention is to provide an apparatus, a system and a method for converting vibrational energy to electric potential which may charge a battery using the vibrational energy.

And, another advantage of the present invention is to provide an apparatus, a system and a method for converting vibrational energy to electric potential which use the vibrational energy of a vehicle to power the vehicle.

Moreover, an advantage of the present invention is to provide an apparatus, a system and a method for converting vibrational energy to electric potential which may provide constant current despite variations in tone and/or loudness of sound.

And, another advantage of the present invention is to provide an apparatus, a system and a method for converting vibrational energy to electric potential which may utilize a vocal range of zero to 500 hertz.

A still further advantage of the present invention is to provide an apparatus, a system and a method for converting vibrational energy to electric potential which may provide at least one volt of current to an electrical device.

Yet another advantage of the present invention is to provide an apparatus, a system and a method for converting vibrational energy to electric potential which may provide at least five volts of current to an electrical device.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for converting vibrational energy to electric potential in an embodiment of the present invention.

FIG. 2 illustrates a black box diagram of a system for converting vibrational energy to electric potential in an embodiment of the present invention.

FIG. 3 illustrates a perspective view of a mobile telephone implementing a system for converting vibrational energy to electric potential in an embodiment of the present invention.

FIG. 4 illustrates a perspective view of a mobile telephone implementing a system for converting vibrational energy to electric potential in an embodiment of the present invention.

FIG. 5 illustrates a flowchart of a method for converting vibrational energy to electric potential in an embodiment of the present invention.

FIG. 6 illustrates a flowchart of a method for converting vibrational energy to electric potential in an embodiment of the present invention.

### DETAILED DESCRIPTION OF THE PRESENTLY PREFERRED EMBODIMENTS

The present invention generally relates to an apparatus, a system and a method illustrates a black box diagram of a system for converting vibrational energy to electric potential in an embodiment of the present invention. More specifically, the present invention relates to an apparatus, a system and a method for using vibrational energy from sound to provide voltage to an electrical device. Voltage stored in a capacitor may initiate functioning of the electrical device, and vibrational energy produced by the function of the electrical device may provide current for continued function. Use of the vibrational energy may allow electrical devices to function without a battery and/or exterior electrical wires. The apparatus, the system and the method for converting vibrational energy to electric potential in an embodiment of the present invention may allow continuous use of an electrical device without a need for recharging.

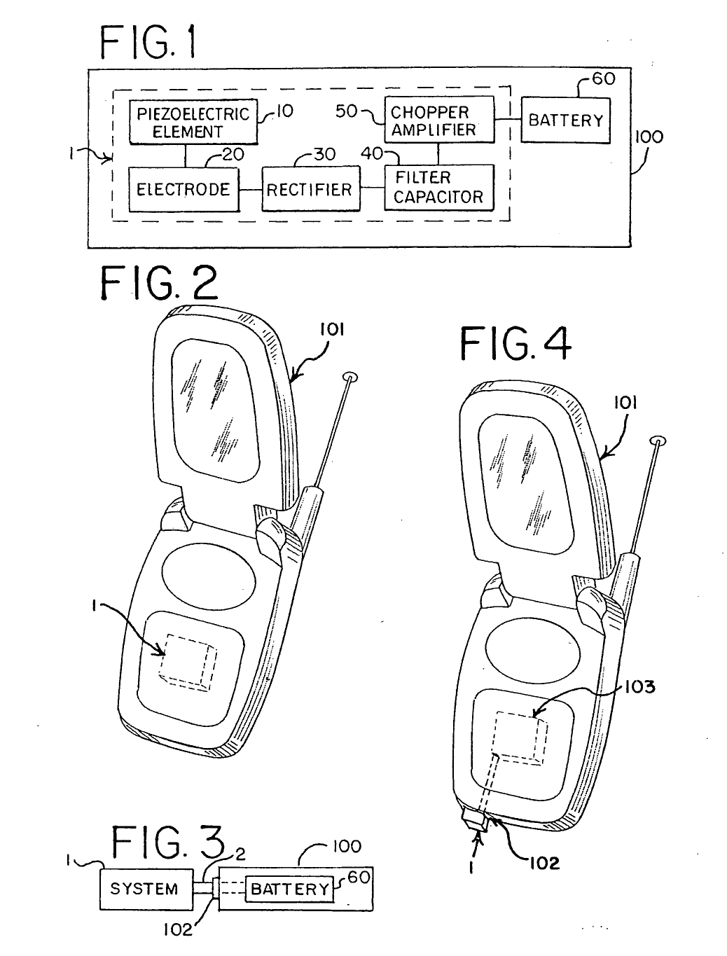

Referring now to the drawings wherein like numerals refer to like parts, FIG. 1 illustrates a black box diagram of a system 1 for converting vibrational energy to electric potential in an embodiment of the present invention. An electrical device 100 may be connected to the system 1 and/or may receive power from the system 1. The system 1 may be located within an interior of the electrical device 100.

The system 1 may have a piezoelectric element 10 that generates an electric potential in response to mechanical stress, such as, for example, vibrational energy from sound. The piezoelectric element 10 may be manufactured from a material having a crystal lattice. For example, the material may be a natural crystal, such as, for example, AlPO₄ (“Berlinite”), SiO₂ tetrahedra (“quartz”), KNaC₄H₄O₆.4H₂O (“Potassium sodium tartrate”), Al₂SiO₄ (F₁OH)₂ (“topaz”) and/or a tourmaline-group mineral. The piezoelectric material may be a man-made crystal, such as, for example, GaPO₄ (“gallium orthophosphate”) and/or La₃Ga₅SiO₁₄ (“Langasite”). For example, the piezoelectric material may be a man-made ceramic, such as, for example, BaTiO₃ (“barium titanate”), PbTiO₃ (“lead titanate”), Pb[ZrₓTi₁₋ₓ]O₃ wherein 0<x<1 (“lead zirconate titanate”), KNbO₃ (“potassium niobate”), LiNbO₃ (“lithium niobate”), LiTaO3 (“lithium tantalate”), NaₓWO₃ (“sodium tungstate”), Ba₂NaNb₅O₅ and/or Pb₂KNb₅O₁₅. The piezoelectric material may be a polymer, such as, for example, polyvinylidene fluoride (“PVDF”). It should be understood that the present invention should not be limited to a specific embodiment of the piezoelectric material.

For example, the piezoelectric material may be a crystal that does not have a center of symmetry, such as, for example, crystals in crystal classes 1, 2, m, 222, mm2, 4, −4, 422, 4 mm, −42 m, 3, 32, 3 m, 6, −6, 622, 6 mm, −62 m, 23 and/or −43 m. For example, the piezoelectric material may be a crystal that spontaneously polarizes, such as, for example, crystals in crystal classes 1, 2, m, mm2, 4, 4 mm, 3, 3 m, 6 and/or 6 mm. It should be understood that the present invention should not be limited to a specific embodiment of the crystal class of the piezoelectric material.

The piezoelectric element 10 may have a size that may be small relative to a size of the electrical device 100. For example, the piezoelectric element 10 may have a length and/or a width that may be less than one inch. In a preferred embodiment, the length and/or the width may be less than 0.75 inches. The piezoelectric element 10 may have a shape, such as, for example, a disc, a plate, a cylinder or a cube. It should be understood that the present invention should not be limited to a specific embodiment of the size and/or shape of the piezoelectric element 10.

In response to vibrational energy, the piezoelectric element 10 may expand and/or contract to generate an electric charge across the crystal lattice of the piezoelectric material. The vibrational energy may be provided by ambient energy from sound in an environment within which the system 1 is located. The environment may have ambient noise, such as, for example, in the range of zero to 80 decibels, that may provide the vibrational energy. Further, a vocal range of zero to 500 Hertz may provide the vibrational energy for the system 1. Still further, the vibrational energy may be provided by vibrations produced by the function of the electrical device 100 that may be connected to the system 1, such as, for example, vibrations produced by a speaker during use. The piezoelectric element 10 may convert the vibrational energy to electric potential having alternating current voltage (“AC voltage”).

An electrode 20 may be connected to, may be attached to and/or may be affixed to the piezoelectric element 10. For example, the electrode 20 may be a wire, an element and/or a rod. The electrode 20 may be manufactured from a metal substance, such as, for example, copper, silver, lead and/or zinc. The electrode 20 may be manufactured from a non-metal substance, such as, for example, carbon. The electrode 20 may transmit the electric potential that may be generated by the piezoelectric element 10. In an embodiment, the system 1 may have more than one electrode 20. It should be understood that the present invention should not be limited to a specific embodiment of the electrode 20.

The system 1 may have a rectifier 30 that may receive the electric potential generated by the piezoelectric element 10 and/or transmitted by the electrode 20. The rectifier 30 may convert the electric potential having AC voltage to electric potential having a direct current voltage (“DC voltage”). A filter capacitor 40 may process varying voltage levels of the electric potential received from the rectifier 30. The filter capacitor 40 may establish a consistent voltage level for a DC signal received from the rectifier 30. The filter capacitor 40 may establish the consistent voltage level despite variations in tone and/or volume of the sound in the environment within which the system 1 is located.

The system 1 may have a chopper amplifier 50. The chopper amplifier 50 may disassemble a DC input signal so that the DC input signal may be processed as if the DC input signal were an AC signal. The chopper amplifier 50 may then integrate the processed input signal back to a DC signal. Thus, the chopper amplifier 50 may amplify relatively small DC signals. The system 1 may produce more than one volt of the electric potential. In a preferred embodiment, the system 1 may produce more than five volts of the electric potential.

The piezoelectric element 10, the electrode 20, the rectifier 30, the filter capacitor 40 and/or the chopper amplifier 50 may provide the electric potential to the electrical device 100 connected to the system 1. As generally shown in FIG. 2, the electrical device 100 may have a battery 60. The piezoelectric element 10, the electrode 20, the rectifier 30, the filter capacitor 40 and/or the chopper amplifier 50 may provide the electric potential to the battery 60 to recharge the battery 60. The battery 60 may be, for example, a Nickel Cadmium battery, a Nickel Metal Hybride battery, a Lithium Ion battery, a Lithium-Polymer battery, a solid state battery or the like. The battery 60 may provide power to the electrical device 100 connected to the system 1. It should be understood that the present invention should not be limited to a specific embodiment of the battery 60.

As previously set forth, the system 1 may be located within the interior of the electrical device 100 as generally shown in FIG. 1. For example, as generally shown in FIG. 2, if the electrical device 100 is a mobile phone 101, the system 1 may be located within an interior of the mobile phone 101. In this embodiment, the electrical potential provided by the system 1 may be sufficient for powering the mobile phone 101, and/or the mobile phone 101 may not have the battery 60.

Alternatively, the system 1 may be located outside of the electrical device 100 and/or may have a connector 2 that may attach the system 1 to the electrical device 100 as generally shown in FIG. 3. For example, the connector 2 may attach the system 1 to a port 102 on an exterior surface of the electrical device 100. For example, as generally shown in FIG. 4, the system 1 may be attached by the connector 2 to a port 102 on the mobile phone 101 that may be normally used for recharging a battery 103 of the mobile phone. The system 1 may recharge the battery 103.

A user may speak into the mobile phone 101 and/or the mobile phone 101 may output sound. Thus, use of the mobile phone 101 may provide the vibrational energy for powering the mobile phone 101 and/or recharging the battery 103 of the mobile phone 101.

As another example, the electrical device 100 may be a wireless speaker. The wireless speaker may output sound and/or may vibrate, and the sound and/or vibrations may provide the vibrational energy for powering the wireless speaker. As further examples, the electrical device 100 may be a cordless power tool, a television, a two-way radio, a mobile media player, a personal digital assistant (“PDA”), a laptop computer, a handheld remote control, a wireless industrial instrument, a Bluetooth device (registered trademark of Bluetooth SIG, Inc.) and/or medical equipment. It should be understood that the present invention should not be limited to a specific embodiment of the electrical device 100.

An automobile is yet another example of a use of the present invention. The system 1 may obtain the vibrational energy from vibrations of the automobile and/or may be used instead of an alternator. The alternator is traditionally used in the automobile to charge a battery of the automobile and/or to power an electric system of the automobile when an engine of the automobile is in use. Instead of the alternator, the automobile may use the system 1 to charge the battery of the automobile and/or to power the electric system of the automobile.

FIG. 5 generally illustrates a method 200 for converting vibrational energy to electric potential in an embodiment of the present invention. While the electrical device is not in use, the system 1 and/or the piezoelectric element 10 may convert vibrational energy to electric potential and/or store the electrical potential as generally shown at step 201. The electrical device 100 may be activated using electric potential from the system 1 and/or the piezoelectric element 10 as generally shown at step 202. Use of the electrical device 100 may provide the system 1 with the vibrational energy as generally shown at step 203. The system 1 may convert the vibrational energy to the electric potential and thereby provide power to the electrical device 100 that may sustain use of the electrical device 100 as generally shown at step 204.

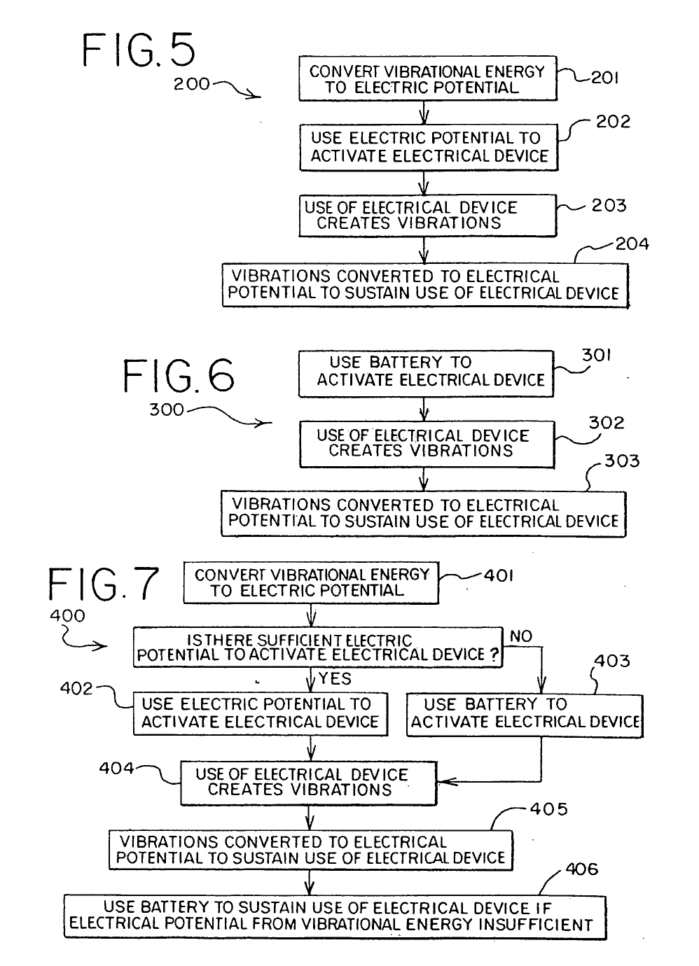

FIG. 6 generally illustrates a method 300 for converting vibrational energy to electric potential in an embodiment of the present invention. The electrical device 100 may be activated using electric potential from the battery 60 as generally shown at step 301. Use of the electrical device 100 may provide the system 1 and/or the piezoelectric element 10 with the vibrational energy as generally shown at step 302. The system 1 and/or the piezoelectric element 10 may convert the vibrational energy to the electric potential and/or may provide power to the electrical device 100 that may sustain use of the electrical device 100 as generally shown at step 303. Alternatively, the system 1 and/or the piezoelectric element 10 may recharge the battery 40 of the electrical device 100.

FIG. 7 generally illustrates a method 400 for converting vibrational energy to electric potential in an embodiment of the present invention. While the electrical device is not in use, the system 1 and/or the piezoelectric element 10 may convert vibrational energy to electric potential and/or may store the electrical potential as generally shown at step 401. The electrical device 100 may be activated using electric potential from the system 1 and/or the piezoelectric element 10 as generally shown at step 402. The electrical device 100 may be activated by power from the battery 60 if the system 1 and/or the piezoelectric element 10 do not provide sufficient electric potential as generally shown at step 403. For example, the electrical device 100 may be activated by power from the battery 60 if the electrical potential converted from the vibrations is less than a predetermined amount. Use of the electrical device 100 may provide the system 1 and/or the piezoelectric element 10 with the vibrational energy as generally shown at step 404. The system 1 and/or the piezoelectric element 10 may convert the vibrational energy to the electrical potential and thereby provide power to the electrical device 100. The electrical potential generated by the system 1 and/or the piezoelectric element 10 may sustain use of the electrical device 100 as generally shown at step 405. The electrical device 100 may sustain function using power from the battery 60 if the system 1 and/or the piezoelectric element 10 do not provide sufficient electric potential as generally shown at step 406. For example, the electrical device 100 may sustain function using power from the battery 60 if the electrical potential converted from the vibrational energy is less than a predetermined amount.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for providing power to an electrical device, the system comprising:
a piezoelectric element wherein the piezoelectric element is manufactured from a crystal that does not have a center of symmetry wherein the piezoelectric element generates an electric potential in response to vibration; and
a rectifier connected to the piezoelectric element wherein input for the rectifier is the electric potential generated by the piezoelectric element in AC voltage and output for the rectifier is the electric potential in DC voltage.

2. The system of claim 1 further comprising:
an amplifier connected to the piezoelectric element wherein the amplifier increases the electric potential generated by the piezoelectric element.

3. The system of claim 1 further comprising:
an amplifier connected to the rectifier wherein the amplifier allows the electric potential to be processed as an AC signal.

4. The system of claim 1 further comprising:
a capacitor connected to the piezoelectric element.

5. The apparatus of claim 1 further comprising:
an electrode connected to the piezoelectric element wherein the electrode transmits the electric potential from the piezoelectric element to the rectifier.

6. The system of claim 1 further comprising:
connecting means attached to the piezoelectric element and the rectifier.

7. An apparatus for providing power to a mobile phone wherein the mobile phone has a battery charged by the apparatus, the apparatus comprising:
a piezoelectric component wherein the piezoelectric component is manufactured from a crystal that does not have a center of symmetry wherein the piezoelectric component generates an electric potential in response to vibration; and
connecting means attached to the piezoelectric component.

8. The apparatus of claim 7 further comprising:
an amplifier connected to the piezoelectric component wherein the amplifier increases the electric potential generated by the piezoelectric component.

9. The apparatus of claim 7 further comprising:
a rectifier connected to the piezoelectric component wherein input for the rectifier is the electric potential generated by the piezoelectric component in AC voltage and the output for the rectifier is the electric potential in DC voltage.

10. The apparatus of claim 7 further comprising:
an electrode connected to the piezoelectric component wherein the electrode receives the electric potential from the piezoelectric component.

11. A method for providing electrical power to an electrical device wherein the electrical device has an exterior and an interior, the method comprising the steps of:
converting vibrations to electric potential wherein the vibrations are converted to the electrical potential by a piezoelectric element wherein the piezoelectric element is manufactured from a crystal that does not have a center of symmetry; and
transmitting the electrical potential to the electrical device.

12. The method of claim 11 further comprising the step of:
amplifying the electrical potential.

13. The method of claim 11 further comprising the step of:
charging a battery of the electrical device with the electrical potential.

14. The method of claim 11 further comprising the step of:
transmitting power from a battery of the electrical device if the electrical potential converted from the vibrations is less than a predetermined amount.

15. The method of claim 11 further comprising the step of:
converting the electrical potential from AC voltage to DC voltage.

16. The method of claim 11 further comprising the step of:
activating the electrical device with the electrical potential.

17. The method of claim 11 further comprising the step of:
using the electrical potential to sustain a function of the electrical device.

18. The method of claim 11 further comprising the step of:
processing the electrical potential.

19. The method of claim 11 further comprising the step of:
connecting the piezoelectric element to the exterior of the electrical device.

20. The method of claim 11 further comprising the step of:
connecting the piezoelectric element to the interior of the electrical device.
